(19) United States
(12) Patent Application Publication
(10) Pub. No.: US 2004/0155172 A1
(43) Pub. Date: Aug. 12, 2004

(54) Compact vitamin d-production monitor

(76) Inventor: Anuthep Benja-Athon, New York, NY (US)

Correspondence Address: ANUTHEP BENJA-ATHON, M.D., 210 East 36th Street, New York, NY, 10016, US

(21) Appl. No.: 10/358,671

(22) Filed: Feb. 6, 2003

(51) Int. Cl. G01J 1/20; G01C 21/02; G01C 21/24

(52) U.S. Cl. 250/203.3

(57) ABSTRACT

A compact device for quantifying and showing a time interval wherein an individual is exposed to lights in particular sunlight that cause the synthesis and production of vitamin D and its related precursors and derivatives adaptable to convert a quantity of absorbed sunlight to a quantity of electricity which is used to correlate, quantify and show the time interval required for the aforementioned synthesis and production by the body and skin subject to the same source, intensity and condition of light. The device also comprises various functions of tracking and showing various time intervals and junctures and maintaining and showing a flowsheet of time intervals and the acquisitions of vitamin D and its related precursors and derivatives.

### FIELD OF INVENTION

A device for accounting a time interval of light exposure for the production and synthesis of vitamin D.

### BACKGROUND OF THE INVENTION

Vitamin D, its precursors and derivatives are vital vitamin and components in the growth, function and homeostasis of all humans. They are optimally derived, synthesized and produced by the body and by the skin being exposed to sunlight. However, vitamin D deficiency is an extremely common and prevalent in most Americans. The problem of said deficiency is further compounded by the current and popular fear of the association of the exposure of sunlight to skin cancer. Said deficiency causes widespread and prevalent problems in most Americans with dire consequences in growing children and seniors.

The present invention is a compact device to be used by any individual in a light setting. The device provides and informs an individual an interval of time, a plurality of time intervals spreading over day, days or weeks and a summation of time needed to have adequate or optimal lights in particular sunlight exposure so as to synthesize and produce an adequate or optimal amount of vitamin D and its precursors and derivatives and minimize the risk of cancers relating to the excessive exposure to light.

### SUMMARY OF THE INVENTION

Vitamin D deficiency is due to inadequate or no exposure to sunlight for various reasons including fear of over exposure to sunlight.

The present invention is a compact device designed to be like a watch, clock or a strip of displaying monitor for quantifying and showing a time interval wherein an individual's body including skin is exposed to a quantity of sunlight causing the synthesis and production of a quantity of vitamin D and its related precursors and derivatives in the body including said skin wherein a quantity of absorbed light produces a corresponding quantity of electricity means for correlating, quantifying and showing said time interval required for said synthesis and production by said body and skin being exposed to same source and intensity of light. A calculator and various formulas involving an electricity-synthesis-production correlation is effected by a plurality of calculations based on a plurality of formulas whose dependent variables include light intensity at locations, in seasons, latitudes, longitudes, altitudes, environmental settings, light intensities, genders, skin colors, races and ethnicities, body fat contents, amount of naked skin being exposed to light, amount of hair for a given body region being exposed to light, said individual's diets, intake of vitamins including vitamin D and its precursors and derivatives, genetics, diseases, body sizes, dimensions, weights, physical activities, ambiences and applications of various skin oils and lotions.

The device also comprises various functions of tracking and showing various time intervals and junctures and maintaining and showing a flowsheet of time intervals and the acquisitions of vitamin D and its related precursors and derivatives.

### PREFERRED EMBODIMENTS OF THE INVENTION

The present invention is a device for quantifying and showing a time interval wherein an individual's body including skin is exposed to a quantity of sunlight causing the synthesis and production of a quantity of vitamin D and its related precursors and derivatives in the body including said skin wherein a quantity of absorbed light produces a corresponding quantity of electricity means for correlating, quantifying and showing said time interval required for said synthesis and production by said body and skin being exposed to same source and intensity of light.

One of the preferred embodiments of the present invention is a compact device manufactured to be a watch, a disc or a strap adaptable to be worn on the wrist, placed on a shoulder or a head, table and the like or be attached to a shirt collar, jacket, umbrella, hat, cap, pole and any other outdoor items. Means of securing and fastening such as, but not limited to, glue, belt and buckle, hoops and loops, straps, pins and various types of base means for supporting said devices be used.

The device can incorporate various types of colored, polarized filters and lenses to select one or a plurality of wavelengths of light for the purpose set forth by the invention. With or without protecting cover, filters and lenses, the device comprises light-absorbing panel means for absorbing light. The panel such as solar panel comprises of light-absorbing photocells adaptable to convert absorbed light into electricity. Sunlight absorbed by this photovoltaic electricity generation panel is converted to electricity. The electricity is conducted and measured by a electricity-accounting meter. The device comprises circuit board incorporates various wires, transistors, transformers, conductors, resistors and the like to allow the functions of the device described herein. Using said meter and calculator and a plurality of formulas, a quantity of electricity produced by the absorbed sunlight can be correlated to the synthesis and production of a quantity of vitamin D and its related precursors and derivatives in the body including said skin being exposed to the same source and intensity of light in the same environment and setting. However, the above formulas contain and account for dependent variables such as, but not limited, light intensity at locations, in seasons, latitudes, longitudes, altitudes, environmental settings, light intensities, genders, skin colors, races and ethnicities, body fat contents, amount of naked skin being exposed to light, amount of hair for a given body region being exposed to light, said individual's diets, intake of vitamins including vitamin D and its precursors and derivatives, genetics, diseases, body sizes, dimensions, weights, physical activities, ambiences and applications of various skin oils and lotions.

The end results of the above correlations and calculations lead to a display of information such as, but not limited to, a beginning time of exposure to sunlight, an end of exposure to sunlight, a time interval required for exposure to sunlight, a changing and varying time interval required due to changing conditions, settings and environments affecting said exposure to sunlight, a flowsheet of time intervals over a period of days and weeks for the acquisitions of a quantity of vitamin D and its related precursors and derivatives and the quantities, acquisitions, utilizations, requirements, depletions of said synthesis and production.

The device incorporates other ordinary components such as time-telling digital clock and the like.

Although the preferred embodiments have been described, it will be appreciated by those skilled in the art that variations, additions and adaptations to the present invention can be had without departing from the spirit of the invention and the scope of the claims.

1. A means for quantifying and showing a time interval wherein an individual is exposed to lights in particular sunlight that cause the synthesis and production of vitamin D and its related precursors and derivatives from the chemical precursors in a human and animal body including skin of said individual adaptable to convert a quantity of absorbed light to a quantity of electricity produced as a means for correlating, quantifying and showing said time interval required for said synthesis and production by said body and skin being exposure to same source of light, as a means for informing said individual a beginning and an end of said interval and said interval, as a means for calculating and accounting for quantities, acquisitions, utilizations, requirements, depletions of said synthesis and production, and as a means for producing and maintaining a flowsheet of time intervals over a period of days and weeks for the acquisitions of a quantity of vitamin D and its related precursors and derivatives comprises:
a means for selectively transmitting a wavelength of light to said means for absorbing light;
a means for selectively transmitting a plurality of wavelengths of light to said means for absorbing light;
a means for absorbing light;
a means for converting light into electricity;
a means for converting absorbed band of wavelength of light into electricity;
a means for quantifying an amount of absorbed light per unit time;
a means for quantifying an amount of absorbed wavelength of light per unit time;
a means for quantifying an amount of electricity being converted from an amount of absorbed light;
a means for measuring a quantity electricity being converted from an amount of absorbed light per unit time;
a means for measuring a quantity electricity being converted from an amount of absorbed wavelength of light per unit time;
a means for quantifying an amount of electricity being converted from an amount of absorbed wavelength of light per unit time;
a formula means for correlating a quantity of absorbed light to a quantity of electricity produced and a quantity of synthesized and produced vitamin D and its related precursors and derivatives;
a formula means for calculating and deriving a time interval for said synthesis and production from the light absorbed by said body and skin;
a calculator means for manipulating said formula means to derive a said time interval;
a means for informing an individual the amount of time needed to absorb an amount of light for said synthesis and production;
a disposable and rechargeable battery means for powering the electronic components of said means for quantifying;
a means for using light-derived electricity means for powering electronic components of said means for quantifying;
a means for using light-derived electricity for charging a rechargeable battery means for powering electronic components of said means for quantifying;
a watch means for showing time;
a means for showing said a plurality of said time intervals;
a means for showing a beginning and an end of a time interval;
a means for informing the time of completion of said exposure to light;
a means for informing an individual the time of completion of said exposure to light; and
a means for securing said means for quantifying to said individual's body, garments and surrounding fixtures.

2. The means for quantifying a time interval according to claim 1 wherein said means for selectively transmitting a wavelength of light to a means for absorbing light is a colored filter means for transmitting a wavelength of light to a means for absorbing light.

3. The means for quantifying a time interval according to claim 1 wherein said means for selectively transmitting a plurality of wavelengths of light to said means for absorbing light is a plurality of colored filters.

4. The means for quantifying a time interval according to claim 1 wherein said means for absorbing light is light-absorbing photocells.

5. The means for quantifying a time interval according to claim 1 wherein said means for absorbing light is a solar panel.

6. The solar panel according to claim 5 comprises light-absorbing photocells.

7. The means for quantifying a time interval according to claim 1 wherein said means for converting light into electricity is a light-absorbing cell means for converting light into electricity.

8. The means for quantifying a time interval according to claim 1 wherein said means for converting light into electricity is a solar cell means for converting sunlight into electricity.

9. The means for quantifying a time interval according to claim 1 wherein said means for converting light into electricity is a photovoltaic electricity generation panel means for converting sunlight into electricity.

10. The means for quantifying a time interval according to claim 1 wherein said means for converting absorbed band of wavelength of light into electricity is a photovoltaic electricity generation panel means for converting said band of wavelength of light into electricity.

11. The means for quantifying a time interval according to claim 1 wherein said means for measuring a quantity of absorbed light per unit time is a light-absorbing meter.

12. The means for quantifying a time interval according to claim 1 wherein means for quantifying an amount of electricity being converted from an amount of absorbed light is an electricity-accounting meter.

13. The means for quantifying a time interval according to claim 1 wherein said means for measuring a quantity electricity being converted from an amount of absorbed light per unit time is an electricity-accounting meter.

14. The means for quantifying a time interval according to claim 1 wherein said means for measuring a quantity electricity being converted from an amount of absorbed wavelength of light per unit time is an electricity-accounting meter.

15. A means for quantifying and showing a time interval wherein an individual's body including skin is exposed to a quantity of sunlight causing the synthesis and production of a quantity of vitamin D and its related precursors and derivatives in the body including said skin wherein a quantity of absorbed light produces a corresponding quantity of electricity means for correlating, quantifying and showing said time interval required for said synthesis and production by said body and skin being exposure to same source and intensity of light, wherein electricity-synthesis-production correlation is effected by a plurality of calculations based on a plurality of formulas whose dependent variables include light intensity at locations, in seasons, latitudes, longitudes, altitudes, environmental settings, light intensities, genders, skin colors, races and ethnicities, body fat contents, amount of naked skin being exposed to light, amount of hair for a given body region being exposed to light, said individual's diets, intake of vitamins including vitamin D and its precursors and derivatives, genetics, diseases, body sizes, dimensions, weights, physical activities, ambiences and applications of various skin oils and lotions, wherein said means for quantifying and showing adaptable to constantly monitor and inform changing said time intervals as a result of varying and fluctuating said dependent variables comprises:
a means for selectively transmitting a wavelength of light to said means for absorbing light;
a means for selectively transmitting a plurality of wavelengths of light to said means for absorbing light;
a means for absorbing light;
a means for converting light into electricity;
a means for converting absorbed band of wavelength of light into electricity;
a means for quantifying an amount of absorbed light per unit time;
a means for quantifying an amount of absorbed wavelength of light per unit time;
a means for quantifying an amount of electricity being converted from an amount of absorbed light;
a means for measuring a quantity electricity being converted from an amount of absorbed light per unit time;
a means for measuring a quantity electricity being converted from an amount of absorbed wavelength of light per unit time;
a means for quantifying an amount of electricity being converted from an amount of absorbed wavelength of light per unit time;
a formula means for correlating a quantity of absorbed light to a quantity of electricity produced and a quantity of synthesized and produced vitamin D and its related precursors and derivatives;
a formula means for calculating and deriving a time interval for said synthesis and production from the light absorbed by said body and skin;
a calculator means for manipulating said formula means to derive a said time interval;
a means for informing an individual the amount of time needed to absorb an amount of light for said synthesis and production;
a disposable and rechargeable battery means for powering the electronic components of said means for quantifying;
a means for using light-derived electricity means for powering electronic components of said means for quantifying;
a means for using light-derived electricity for charging a rechargeable battery means for powering electronic components of said means for quantifying;
a watch means for showing time;
a means for showing said a plurality of said time intervals;
a means for showing a beginning and an end of a time interval;
a means for informing the time of completion of said exposure to light;
a means for informing an individual the time of completion of said exposure to light;
a means for securing said means for quantifying to said individual's body, garments and surrounding fixtures;
a means for informing said individual a beginning and an end of said interval and said interval;
a means for calculating and accounting for quantities, acquisitions, utilizations, requirements, depletions of said synthesis and production;
a means for producing and maintaining a flowsheet of time intervals over a period of days and weeks for the acquisitions of a quantity of vitamin D and its related precursors and derivatives; and

16. A sentinel device for quantifying and showing a time interval for the balancing of the amount of time of exposure to sunlight for the synthesis and production of vitamin D, and its precursors and derivatives by and the avoiding of the damaging sunlight effects on the body including skin of an individual wherein a quantity of absorbed light produces a corresponding quantity of electricity means for correlating, quantifying and showing said time interval required for said synthesis and production by said body and skin being exposure to same source and intensity of light, wherein electricity-synthesis-production relationships are produced by a plurality of calculations in said sentinel device based on a plurality of formulas whose dependent variables include light intensity at locations, in seasons, latitudes, longitudes, altitudes, environmental settings, light intensities, genders, skin colors, races and ethnicities, body fat contents, amount of naked skin being exposed to light, amount of hair for a given body region being exposed to light, said individual's diets, intake of vitamins including vitamin D and its precursors and derivatives, genetics, diseases, body sizes, dimensions, weights, physical activities, ambiences and applications of various skin oils and lotions, wherein said means for quantifying and showing adaptable to constantly monitor and inform changing said time intervals as a result of varying and fluctuating said dependent variables comprises:
a means for selectively transmitting a wavelength of light to said means for absorbing light;
a means for selectively transmitting a plurality of wavelengths of light to said means for absorbing light;
a means for absorbing light;
a means for converting light into electricity;
a means for converting absorbed band of wavelength of light into electricity;
a means for quantifying an amount of absorbed light per unit time;
a means for quantifying an amount of absorbed wavelength of light per unit time;
a means for quantifying an amount of electricity being converted from an amount of absorbed light;
a means for measuring a quantity electricity being converted from an amount of absorbed light per unit time;
a means for measuring a quantity electricity being converted from an amount of absorbed wavelength of light per unit time;
a means for quantifying an amount of electricity being converted from an amount of absorbed wavelength of light per unit time;
a formula means for correlating a quantity of absorbed light to a quantity of electricity produced and a quantity of synthesized and produced vitamin D and its related precursors and derivatives;
a formula means for calculating and deriving a time interval for said synthesis and production from the light absorbed by said body and skin;
a calculator means for manipulating said formula means to derive a said time interval;
a means for informing an individual the amount of time needed to absorb an amount of light for said synthesis and production;
a disposable and rechargeable battery means for powering the electronic components of said means for quantifying;
a means for using light-derived electricity means for powering electronic components of said means for quantifying;
a means for using light-derived electricity for charging a rechargeable battery means for powering electronic components of said means for quantifying;
a watch means for showing time;
a means for showing said a plurality of said time intervals;
a means for showing a beginning and an end of a time interval;
a means for informing the time of completion of said exposure to light;
a means for informing an individual the time of completion of said exposure to light;
a means for securing said means for quantifying to said individual's body, garments and surrounding fixtures;
a means for informing said individual a beginning and an end of said interval and said interval
a means for calculating and accounting for quantities, acquisitions, utilizations, requirements, depletions of said synthesis and production; and
a means for producing and maintaining a flowsheet of time intervals over a period of days and weeks for the acquisitions of a quantity of vitamin D and its related precursors and derivatives.
